(19) United States
(12) Patent Application Publication
(10) Pub. No.: US 2024/0386871 A1
(43) Pub. Date: Nov. 21, 2024

(54) MUSIC GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Shuai YUAN, Beijing (CN); Shangjie SUN, Beijing (CN); Peidao LI, Beijing (CN); Lei SUN, Beijing (CN); Shengli WANG, Beijing (CN)

(21) Appl. No.: 18/447,011

(22) Filed: Aug. 9, 2023

(30) Foreign Application Priority Data
May 17, 2023 (CN) 2023105584145

(51) Int. Cl. G10H 1/00; G10H 1/36

(52) U.S. Cl. CPC G10H 1/0025; G10H 1/366

(57) ABSTRACT

Embodiments of the present disclosure provide a music generation method and apparatus, an electronic device and a storage medium. Initial audio is acquired; a first arrangement template corresponding to the initial audio is acquired, where the first arrangement template is used for adding a soundtrack with a target music style to the initial audio; the initial audio is processed based on the first arrangement template to generate target music. After acquiring the initial audio input by the user, the first arrangement template matched with the initial audio is selected, and the initial audio is processed by using the first arrangement template to add the soundtrack with the target music style to the initial audio, thereby generating the target music.

### CROSS-REFERENCE TO RELATED APPLICATIONS

This application claims priority to Chinese Patent Application No. 202310558414.5, filed on May 17, 2023, which is hereby incorporated by reference in its entirety.

### TECHNICAL FIELD

Embodiments of the present disclosure relate to the field of internet technologies, and in particular, to a music generation method and apparatus, an electronic device and a storage medium.

### BACKGROUND

Currently, production and sharing of personal musical creations is becoming a popular way of information dissemination. For conventional musical creations, it is usually necessary to use a professional device to go through multiple production links such as composing music, recording, and arranging music, in order to complete the production of a musical creation.

However, for conventional music generation and production methods, there are problems of high production cost and poor production quality of musical creations.

### SUMMARY

Embodiments of the present disclosure provide a music generation method and apparatus, an electronic device and a storage medium, so as to overcome the problems of high production cost and low production quality.

In a first aspect, an embodiment of the present disclosure provides a music generation method, including:

acquiring initial audio: acquiring a first arrangement template corresponding to the initial audio, where the first arrangement template is used for adding a soundtrack with a target music style to the initial audio: processing the initial audio based on the first arrangement template to generate target music.

In a second aspect, an embodiment of the present disclosure provides a music generation apparatus, including:
an input module, configured to acquire initial audio;
a processing module, configured to acquire a first arrangement template corresponding to the initial audio, where the first arrangement template is used for adding a soundtrack with a target music style to the initial audio;
an arrangement module, configured to process the initial audio based on the first arrangement template to generate target music.

In a third aspect, an embodiment of the present disclosure provides an electronic device, including:
a processor and a memory connected to the processor in a communication way;
where the memory stores a computer executable instruction;
the processor executes the computer executable instruction stored in the memory to implement the music generation method as described above in the first aspect and the various possible designs of the first aspect.

In a fourth aspect, an embodiment of the present disclosure provides a computer-readable storage medium storing computer executable instructions, when the computer executable instructions are executed by a processor, the music generation method as described above in the first aspect and the various possible designs of the first aspect is implemented.

In a fifth aspect, an embodiment of the present disclosure provides a computer program product including a computer program, when the computer program is executed by a processor, the music generation method as described above in the first aspect and the various possible designs of the first aspect is implemented.

Embodiments of the present disclosure provide a music generation method and apparatus, an electronic device and a storage medium. Initial audio is acquired: a first arrangement template corresponding to the initial audio is acquired, where the first arrangement template is used for adding a soundtrack with a target music style to the initial audio; the initial audio is processed based on the first arrangement template to generate target music. After acquiring the initial audio input by the user, the first arrangement template matched with the initial audio is selected, and the initial audio is processed by using the first arrangement template to add the soundtrack with the target music style to the initial audio, thereby generating the target music, which realizes the effect of directly processing the initial audio into the target music, reduces the difficulty of music production, simplifies the production process and improves the music quality of the generated target music.

### BRIEF DESCRIPTION OF DRAWINGS

In order to illustrate technical solutions in embodiments of the present disclosure or the prior art more clearly, accompanying drawings that need to be used in description of the embodiments or the prior art will be briefly introduced below. It is obvious that the accompanying drawings in the following description are some embodiments of the present disclosure, and for those of ordinary skill in the art, other accompanying drawings may also be acquired according to these accompanying drawings without paying any creative efforts.

FIG. 1 is an application scenario diagram of a music generation method provided by an embodiment of the present disclosure.

FIG. 2 is flow chart I of a music generation method provided by an embodiment of the present disclosure.

FIG. 3 is a flowchart of a specific implementation of step S101 in the embodiment shown in FIG. 2.

FIG. 4 is a schematic diagram of a first interface provided by an embodiment of the present disclosure.

FIG. 5 is a flowchart of a specific implementation of step S102 in the embodiment shown in FIG. 2.

FIG. 6 is a flowchart of a specific implementation of step S1021 in the embodiment shown in FIG. 5.

FIG. 7 is a schematic diagram of another first interface provided by an embodiment of the present disclosure.

FIG. 8 is flow chart II of a music generation method provided by an embodiment of the present disclosure.

FIG. 9 is a schematic diagram for displaying pre-generated music provided by an embodiment of the present disclosure.

FIG. 10 is a schematic diagram of a second interface provided by an embodiment of the present disclosure.

FIG. 11 is a flowchart of a specific implementation of step S206 in the embodiment shown in FIG. 8.

FIG. 12 is a schematic diagram of jumping from a second interface to a third interface provided by an embodiment of the present disclosure.

FIG. 13 is a flowchart of a specific implementation of step S2062 in the embodiment shown in FIG. 11.

FIG. 14 is a flowchart of a specific implementation of step S207 in the embodiment shown in FIG. 8.

FIG. 15 is a structural block diagram of a music generation apparatus provided by an embodiment of the present disclosure.

FIG. 16 is a schematic structural diagram of an electronic device provided by an embodiment of the present disclosure.

FIG. 17 is a schematic structural diagram of hardware of an electronic device provided by an embodiment of the present disclosure.

### DESCRIPTION OF EMBODIMENTS

In order to make objectives, technical solutions and advantages of embodiments of the present disclosure clearer, the technical solutions in the embodiments of the present disclosure will be clearly and completely described below with reference to the accompanying drawings in the embodiments of the present disclosure. It is clear that, the described embodiments are some embodiments of the present disclosure, rather than all embodiments. All other embodiments obtained by a person of ordinary skill in the art based on the embodiments of the present disclosure without creative efforts shall fall within the protection scope of the present disclosure.

It should be noted that the user information (including but not limited to user device information, user personal information, etc.) and data (including but not limited to data for analysis, stored data, displayed data, etc.) involved in the present disclosure are all information and data authorized by the user or fully authorized by all parties, and the collection, use and processing of relevant data need to comply with relevant laws, regulations and standards of relevant countries and regions, and corresponding operation portals are provided for the user to choose authorization or rejection.

The application scenarios of the embodiments of the present disclosure are explained below:

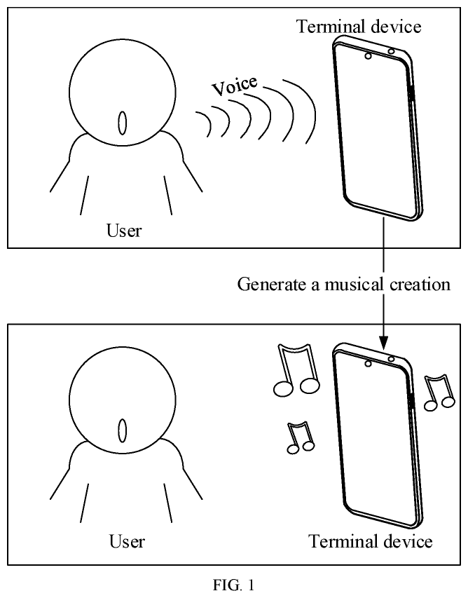

FIG. 1 is an application scenario diagram of a music generation method provided by an embodiment of the present disclosure. The music generation method provided by an embodiment of the present disclosure may be applied to an application scenario of generating personal music creations. More specifically, as shown in FIG. 1, the method provided by the embodiment of the present disclosure may be applied to a terminal device, such as a smart phone, and the music generation method provided by the embodiment is implemented by running a music generation application (APP) on the terminal device. Specifically, for example, after a user triggers a recording component in the music generation application, the terminal device starts to collect voice emitted by the user, such as a melody and a song that are softly hummed, and then, based on the collected voice of the user, the terminal device automatically generates a soundtrack matching the collected voice, mixes it, and then generates a musical creation and plays it to realize the user's audition: furthermore, if the user is not satisfied with the musical creation after the audition, the chord and the arrangement of the musical creation can be further modified until a satisfactory musical creation is generated.

In the prior art, for conventional musical creations, it is usually necessary to use professional equipment to complete the production of a musical creation through multiple production links such as composing music, recording and arranging music. However, for the conventional music generation and production methods, there are problems of high production cost and poor production quality of musical creations. An embodiment of the present disclosure provides a music generation method to solve the above problems.

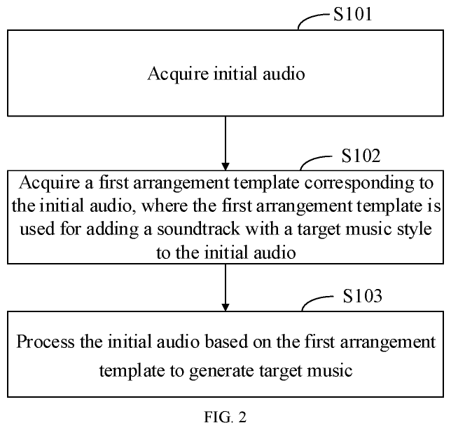

With reference to FIG. 2, FIG. 2 is flow chart I of a music generation method provided by an embodiment of the present disclosure. The method of the present embodiment may be applied to a terminal device, the music generation method includes the following.

Step S101: acquire initial audio.

Exemplarily, in a possible implementation, referring to the schematic diagram of the application scenario shown in FIG. 1, the terminal device first collects a sound signal through a sound collection unit, such as a microphone, so as to obtain the voice emitted by a user, that is, the initial audio. More specifically, for example, a melody and a tune, etc., hummed by the user, the initial audio may contain only melody information (i.e., only a hummed melody), or only semantic information (i.e., only pronounced lyrics), or may contain both melody information and semantic information (i.e., the hummed melody and lyrics), which are not specifically limited here. As for running a target application that can be used to generate a musical creation, there is no specific limitation here.

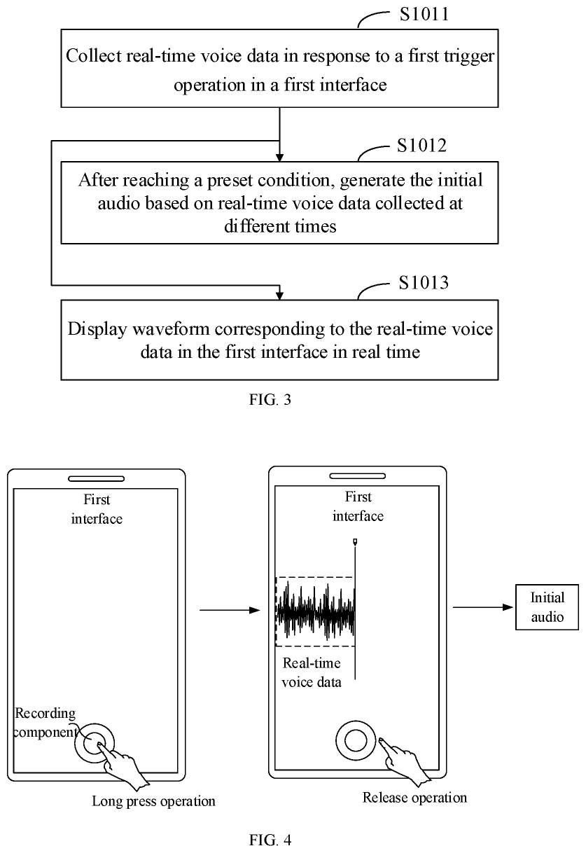

Further, in a possible implementation, after the terminal device runs the target application, a recording component is set in a first interface of the target application, and the collection of the initial audio may be achieved in response to a first trigger operation for the recording component. Specifically, as shown in FIG. 3, the specific implementation manner of step S101 includes:

step S1011: collect real-time voice data in response to a first trigger operation in a first interface:

step S1012: after reaching a preset condition, generate the initial audio based on real-time voice data collected at different times.

FIG. 4 is a schematic diagram of a first interface provided by an embodiment of the present disclosure, the following in conjunction with FIG. 4 to describe the above process. Exemplarily, the first interface is an audio recording interface, the first trigger operation is, for example, clicking or long pressing (a long press operation as shown in the figure) the recording component in the first interface, and then the terminal device starts to continuously collect sound signals and generate time-series based real-time voice data. The preset condition is, for example, releasing the long press for the recording component (a release operation as shown in the figure), or, elapsing a preset time. After reaching the preset condition, the terminal device saves the real-time voice data collected at different times during the above time period as input data.

In an implementation, after step S1011, it further includes:
step S1013: display waveform corresponding to the real-time voice data in the first interface in real time.

In an implementation, after the collection of the real-time voice data is started, as shown in FIG. 4, a waveform corresponding to a current time is also displayed in the first interface, and the waveform is composed of real-time voice data collected from the collection start time before the current time to the current time. Specifically, the waveform is composed of a plurality of numerical points, each of which corresponds to a collection time, and values of the numerical points represent an audio amplitude corresponding to the real-time voice data.

In the steps of the present embodiment, by the first trigger operation for the first interface, the real-time collection of the initial audio is realized, which can realize flexible control of the recording process of the initial audio, and improve the recording efficiency of the initial audio in combination with waveform display.

Further, the first interface is also provided with a first setting component, and before acquiring the initial audio, the following are further included: step S100: receive a first setting operation for a first setting component in the first interface, where the first setting operation is used for setting a target type of a vocal effect.

Correspondingly, in another possible implementation, the specific implementation manner of step S101 includes:
step S1014: perform sound collection in response to the first trigger operation to obtain an original voice;
step S1015: process the original voice to obtain the initial audio with the target type of the vocal effect.

Exemplarily, firstly, the terminal device collects sound information by using the sound collection unit to obtain the original voice, and the specific implementation manner may be referred to implementation manner of the above steps S1011-S1012, which will not be repeated. Then, on the basis of the original voice, for example, through the target type of the vocal effect selected by the first setting operation, the original voice is processed, thereby changing the sound characteristics of the original voice. The vocal effect is the timbre of the vocal singing, and the type of vocal effect may be represented by the type of music, for example, the type of vocal effect includes Pop, Jazz, etc. In other possible implementations, the type of vocal effect may also be a sub-type further refined based on the above classification, such as city Pop, classic Pop, etc., and there is no specific limitation here.

Further, the first setting operation may include two sub-operations, which are respectively used for displaying and triggering different types of vocal effects. For example, when responding to a first setting sub-operation input by the user, the terminal device triggers the corresponding first setting component to display several vocal effect identifications, and then the terminal device responds to a second setting sub-operation input by the user to select the corresponding target vocal effect identification, thereby obtaining first recording information representing the vocal effect of the target type. The first recording information may be a weighted coefficient sequence composed of weighting coefficients for different sound frequencies, a frequency value at at least one frequency point of the original voice is weighted by the first recording information, so as to obtain the initial audio with the target type of vocal effect.

In the steps of the present embodiment, the first recording information is obtained before the initial audio is collected, the adjustment of the initial audio is realized, so that the initial audio has a personalized vocal effect, thereby improving the listening quality of the subsequently generated target music.

In another possible implementation, the specific implementation manner of step S101 includes:
a voice file is selected in response to a first loading operation in a first interface; and the voice file is loaded to obtain the initial audio. The voice file is a pre-generated file containing a sound signal. After being obtained locally or remotely through the first loading operation, the voice file is loaded to the terminal device, so as to obtain a music signal in the voice file, which is equivalent to the original voice obtained in the previous step. After that, the initial audio may be obtained after processing the music signal (for example, setting the vocal effect). The specific implementation manner is similar to the introduction described previously, and will not be repeated here.

Step S102: acquire a first arrangement template corresponding to the initial audio, where the first arrangement template is used for adding a soundtrack with a target music style to the initial audio.

Exemplarily, after obtaining the initial audio, according to a characteristic of the initial audio, an arrangement template matching the characteristic, namely the first arrangement template, is determined, and the first arrangement template is used for adding a soundtrack to the initial audio. Arrangement refers to the process of configuring elements such as musical instruments, chords, bass, harmony and the like on the basis of the main melody. The arrangement template is a kind of template data used to realize the above music arrangement in a fixed collocation manner. The arrangement template is pre-generated, and based on the characteristic of the initial audio, an arrangement template matching the characteristic of the initial audio is selected, that is, the first arrangement template.

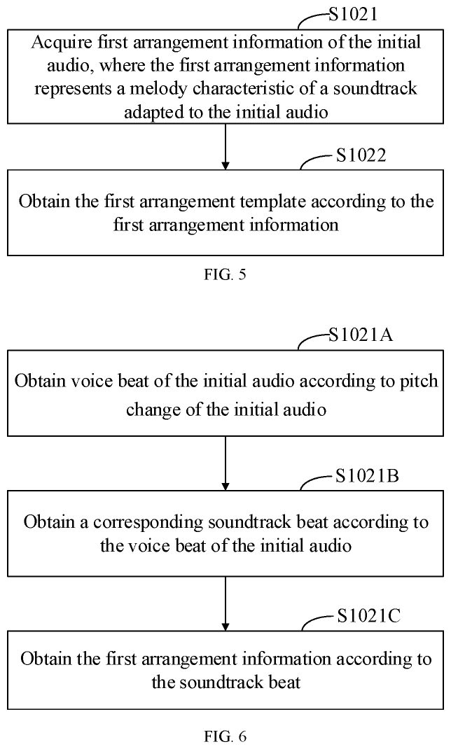

In a possible implementation, as shown in FIG. 5, the specific implementation manner of step S102 includes:
step S1021: acquire first arrangement information of the initial audio, where the first arrangement information represents a melody characteristic of a soundtrack adapted to the initial audio;
step S1021: obtain the first arrangement template according to the first arrangement information.

Exemplarily, the first arrangement information of the initial audio may be user-defined or automatically generated based on the initial audio, or some of the first arrangement information may be user-defined and some of the first arrangement information may be automatically generated based on the initial audio. In a possible implementation, the first arrangement information represents the melody characteristic of the soundtrack adapted to the initial audio, and the melody characteristic of the soundtrack is represented by, for example, the soundtrack beat. Therefore, according to voice beat of the initial audio, the first arrangement information, representing the soundtrack beat that is similar or consistent with the voice beat, may be determined.

Further, exemplarily, as shown in FIG. 6, the specific implementation manner of step S1021 includes:
step S1021A: obtain voice beat of the initial audio according to pitch change of the initial audio;
step S1021B: obtain a corresponding soundtrack beat according to the voice beat of the initial audio;
step S1021C: obtain the first arrangement information according to the soundtrack beat.

Exemplarily, the pitch of the initial audio may be obtained by an amplitude of a digital signal corresponding to the initial audio, and the method for obtaining the pitch is the prior art, which will not be repeated here. After that, based on the change of pitch among different time points (that is, pitch change), the voice beat of the initial audio may be obtained, for example, in a certain frequency dimension, the faster the pitch change, the faster the voice beat, otherwise, the slower the pitch change, the slower the voice beat. Then, based on the voice beat, the soundtrack beat similar to the voice beat is matched, and the corresponding first arrangement information is generated based on the soundtrack beat, where the first arrangement information may be a specific beat identification, at the same time, the preset arrangement template correspondingly has a target rhythm identification representing its rhythm speed and slowness, and the first arrangement template corresponding to the first arrangement information may be determined by comparing the above beat identification and the target rhythm identification.

Further, in a possible implementation, the first interface is also provided with a second setting component, and the second setting component is used for setting the soundtrack beat, and/or a play back speed of the initial audio. In another possible implementation, the specific implementation manner of step S1021 includes:
step 1021D: in response to a second setting operation for a second setting component in a first interface, obtain second recording information, where the second recording information represents a soundtrack beat and/or a playback speed of the initial audio;
step 1021E: obtain the first arrangement information according to the second recording information.

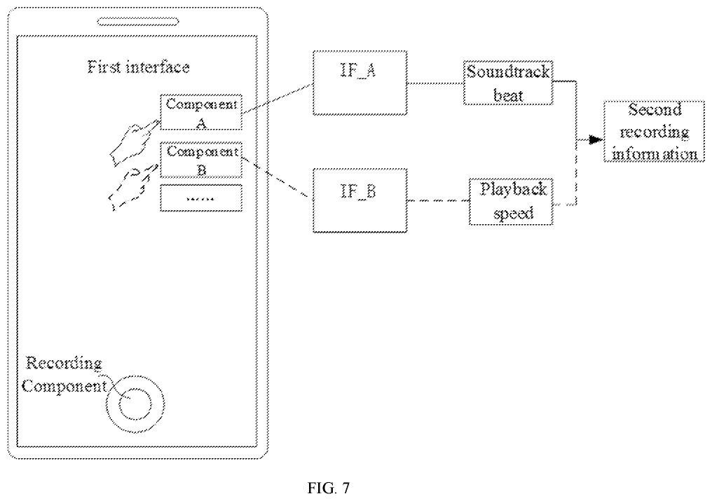

After responding to the second setting operation for the second setting component input by the user, the terminal device may obtain the second recording information based on the personalized selection of the user: where the second recording information represents a soundtrack beat and/or a playback speed of the initial audio. FIG. 7 is a schematic diagram of another first interface provided by an embodiment of the present disclosure. As shown in FIG. 7, the second setting component in the first interface includes a component A and a component B, where the component A is used for setting the soundtrack beat and the component B is used for setting the playback speed. When the user clicks the component A and the component B, respectively, the corresponding setting interface IF_A and setting interface IF_B will pop up. After the user makes specific settings in the setting interface, the terminal device gets the corresponding soundtrack beat and play back speed, so as to obtain the second recording information, and then, the first arrangement information representing the melody characteristic is obtained based on the second recording information.

In the steps of the present embodiment, the personalized setting of the first arrangement information is realized by responding to the second setting operation for the second setting component in the first interface, so as to meet the personalized arrangement requirements of the user, improve the matching degree between the initial audio and the first arrangement template, and improve the music quality of the output target music.

Step S103: process the initial audio based on the first arrangement template to generate target music.

Exemplarily, after the first arrangement template is obtained based on the above steps, in a possible implementation, the first arrangement template may directly generate a soundtrack with a target music style corresponding to the initial audio. Exemplarily, the target music style corresponds to the first arrangement template, and when the first arrangement template is determined based on the first arrangement information, its corresponding target music style is determined. The soundtrack may include multiple soundtrack elements, such as a musical instrument sound effect, a harmonic sound effect, a chord melody. The duration of the soundtrack may be the same as or slightly longer than that of the initial audio, and after generating the soundtrack corresponding to the initial audio based on the first arrangement template, the soundtrack is mixed with the initial audio to obtain the target music.

In the embodiment, initial audio is acquired: a first arrangement template corresponding to the initial audio is acquired, where the first arrangement template is used for adding a soundtrack with a target music style to the initial audio: the initial audio is processed based on the first arrangement template to generate target music. After acquiring the initial audio input by the user, the first arrangement template matched with the initial audio is selected, and the initial audio is processed by using the first arrangement template to add the soundtrack with the target music style to the initial audio, thereby generating the target music, which realizes the effect of directly processing the initial audio into the target music, reduces the difficulty of music production, simplifies the production process and improves the music quality of the generated target music.

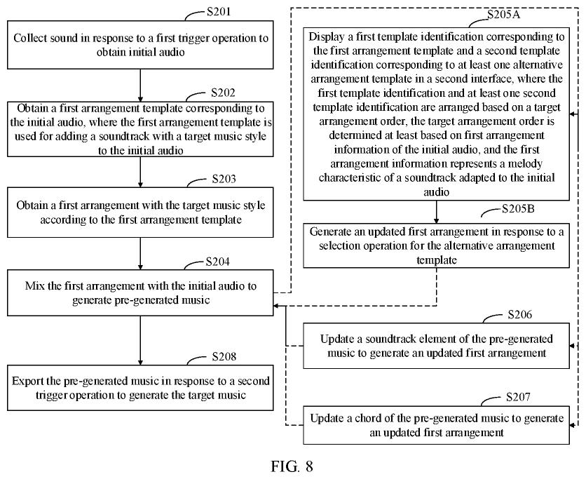

With reference to FIG. 8, FIG. 8 is flow chart II of a music generation method provided by an embodiment of the present disclosure. The present embodiment further refines step S103 based on the embodiment shown in FIG. 2. The music generation method includes:
step S201: collect sound in response to a first trigger operation to obtain initial audio;
step S202: obtain a first arrangement template corresponding to the initial audio, where the first arrangement template is used for adding a soundtrack with a target music style to the initial audio;
step 203: obtain a first arrangement with the target music style according to the first arrangement template.

Exemplarily, in connection with the introduction of acquiring the first arrangement template in the embodiment shown in FIG. 2, after that, the terminal device, for example, processes the input music through the first arrangement template, that is, takes the input music as an input parameter, inputs it the first arrangement template, and the first arrangement template uses its ability to generate a soundtrack of the target music style according to the duration of the input music, to generate a soundtrack that matches the duration of the input music and has the target music style, that is, the first arrangement. The above-mentioned music style may be expressed through differences in chords and soundtrack elements that constitute the soundtrack, and the soundtrack elements include a musical instrument sound effect, a harmony sound effect, a main melody sound effect, etc. That is to say, the first arrangement has corresponding target chords and/or target soundtrack elements.

Step S204: mix the first arrangement with the initial audio to generate pre-generated music.

Further, after the first arrangement is obtained, the first arrangement and the initial audio are mixed, that is, pre-generated music is generated, where mixing the first arrangement and the initial audio refers to setting the pitch (intensity of sound energy) of the first arrangement and the initial audio based on a mixing coefficient, and simultaneously playing the first arrangement and the initial audio based on the set pitch, so as to realize the mixing of the first arrangement and the initial audio.

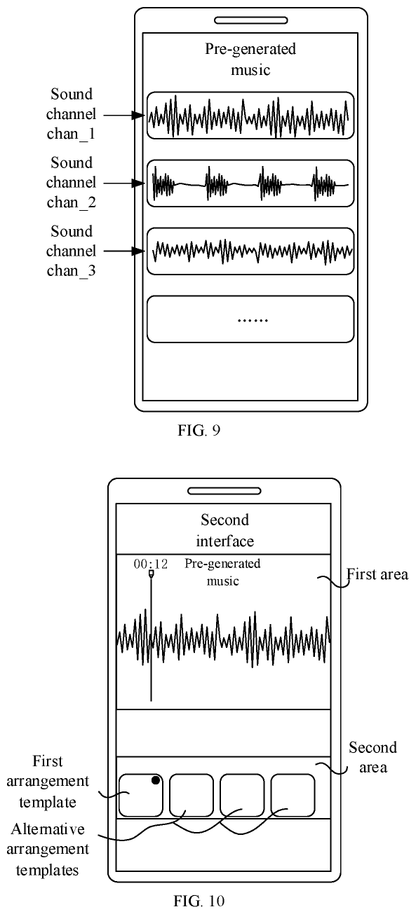

The generated pre-generated music is composed of multiple sound channels, FIG. 9 is a schematic diagram for displaying pre-generated music provided by an embodiment of the present disclosure. Referring to FIG. 9, after the pre-generated music is generated, the pre-generated music will be displayed in the display interface when the corresponding trigger condition (such as receiving a user's specific operation instruction) is reached. Exemplarily, as shown in FIG. 9, the pre-generated music is composed of a sound channel chan_1, a sound channel chan_2 and a sound channel chan_3. The sound channel chan_1 is a vocal channel, which is a sound channel carrying the initial audio; and the sound channel chan_2 and the sound channel chan_3 are musical instrument channels, where the sound channel chan_2 is a sound channel carrying a drum sound effect, and the sound channel chan_3 is a sound channel carrying a keyboard sound effect.

In an implementation, before step S204, the following are further included:
step S200A: display a fifth interface, where the fifth interface is used for setting a mixing coefficient of the first arrangement and the initial audio, and the mixing coefficient represents respective volume values of the first arrangement and the initial audio when mixed;
step S200B: in response to a fifth setting operation for the fifth interface, obtain a target mixing coefficient.

Exemplarily, in the fifth interface, control components respectively corresponding to the first arrangement and the initial audio may be set, such as a slider component and an editable text box component, etc. After the user inputs the fifth setting operation for the above control components, the editing of the mixing coefficient may be realized, for example, by setting the slider component to a specified position, so as to determine a mixing coefficient. The specific implementation form of the fifth setting operation may be set based on needs, and is not limited here. Based on difference fifth setting operations and the above control components, the specific manner in which the terminal device obtains the target mixing coefficient by responding to the fifth setting operation, also varies correspondingly, which will not be repeated here.

Correspondingly, the specific implementation manner of step S204 includes:
the first arrangement and the initial audio are mixed based on the target mixing coefficient to generate pre-generated music. The specific implementation manner of mixing based on the mixing coefficient has been introduced above, and will not be repeated here. It should be noted that the fifth interface is displayed based on the user's trigger instruction. For example, after the user clicks the trigger component corresponding to the fifth interface, the second interface jumps to the fifth interface. Alternatively, a third interface, a fourth interface, etc., jump to the fifth interface. The above steps S200A and S200B may be executed again based on the user's operation after the execution of step S204.

In an implementation, after step S204, the following are further included:
step S205A: display a first template identification corresponding to the first arrangement template and a second template identification corresponding to at least one alternative arrangement template in a second interface, where the first template identification and at least one second template identification are arranged based on a target arrangement order, the target arrangement order is determined at least based on first arrangement information of the initial audio, and the first arrangement information represents a melody characteristic of a soundtrack adapted to the initial audio;
step S205B: generate an updated first arrangement in response to a selection operation for the alternative arrangement template.

In a possible implementation, the pre-generated music is generated by the terminal device after processing the initial audio through a matched first editing target. In this implementation, the user may complete the generation of the pre-generated music and the final target music while only inputting the initial audio (such as a simple melody hummed), which simplifies the process to the greatest extent, reduces the complexity and difficulty of the user's operation, and improves the arrangement melody. However, on this basis, the user may further edit the soundtrack of the pre-generated music on the basis of auditioning the pre-generated music automatically generated, so as to realize more personalized soundtrack arrangement. Specifically, for example, after the pre-generated music is generated, an audio track of the pre-generated music may be further edited, such as adding or deleting an audio track, or separating an audio track. For another example, the pre-generated music may be edited in more detail, such as changing a chord and a musical instrument of the pre-generated music.

FIG. 10 is a schematic diagram of a second interface provided by an embodiment of the present disclosure. As shown in FIG. 10, pre-generated music is automatically generated at the terminal device. On the one hand, a waveform corresponding to the pre-generated music is displayed in a first area of the second interface, where the horizontal axis is a time axis, and a playback position shown in the figure is 00:12, that is, a position at the 12th second of playback time stamp of the pre-generated music. The vertical axis is the amplitude of the pre-generated music at each time point. On the other hand, the currently selected arrangement template, that is, the first arrangement template, and at least one alternative arrangement template, is displayed in a second area of the second interface, where the first template identification and at least one second template identification are arranged based on a target arrangement order, and the target arrangement order is determined at least based on first arrangement information of the initial audio, in short, it is arranged according to a matching degree between each arrangement template and the initial audio, the higher the matching degree, the more front the arrangement position (near the left edge of the second area). The calculation manner of the matching degree of each arrangement template may refer to the introduction of the implementation manner of acquiring the first arrangement template in the embodiment shown in FIG. 2.

Further, after the user clicks on the alternative arrangement template, the terminal device responds to the user's selection operation, determines the selected alternative arrangement template as the first arrangement template, and re-generates the updated first arrangement based on the updated first arrangement template, and returns to step S204 to mix the updated first arrangement with the initial audio, thereby re-generating new pre-generated music.

In an implementation, after step S204, the following are further included:
step S206: update a soundtrack element of the pre-generated music to generate an updated first arrangement.

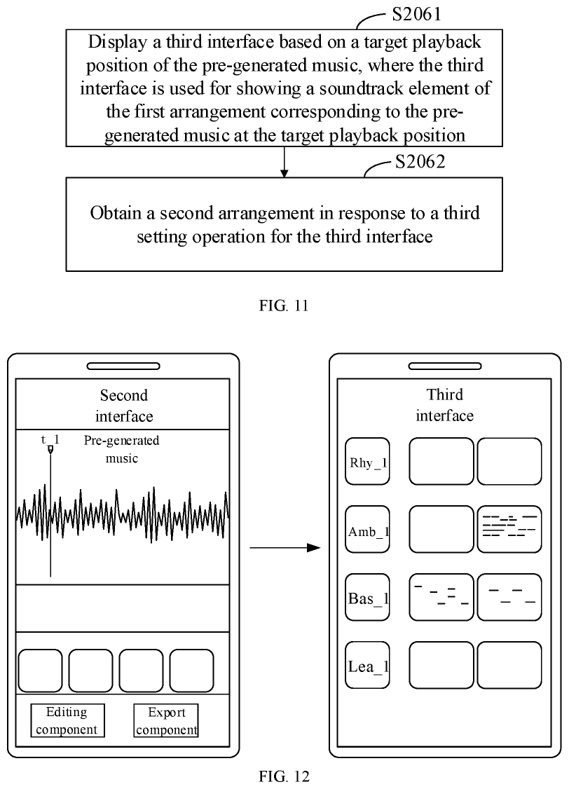

Exemplarily, in addition to the above step of updating the arrangement template, the soundtrack element in the arrangement template may also be updated, which is equivalent to further personalized setting of the arrangement template, so as to obtain the first arrangement that better meets the needs of the user. Exemplarily, the soundtrack element includes at least one of the following: a musical instrument sound effect, a harmonic sound effect, a main melody sound effect and an ambient sound effect. Exemplarily, as shown in FIG. 11, the specific implementation manner of step S206 includes:
step S2061: display a third interface based on a target play back position of the pre-generated music, where the third interface is used for showing a soundtrack element of the first arrangement corresponding to the pre-generated music at the target playback position;
step S2062: obtain a second arrangement in response to a third setting operation for the third interface.

Exemplarily, in the process of displaying and playing the pre-generated music in the second interface, when the pre-generated music is played at the target playback position, or jumps (seek) to the target playback position based on the user's operation, the terminal device displays the third interface after receiving a trigger operation for the third interface input by the user, where the third interface is used for showing a soundtrack element of the first arrangement corresponding to the pre-generated music at the target playback position, and then the user may implement the third setting operation on the basis of the third interface, so as to realize the setting of the soundtrack element, such as changing the musical instrument sound effect, changing the harmonic sound effect. FIG. 12 is a schematic diagram of jumping from a second interface to a third interface provided by an embodiment of the present disclosure. As shown in FIG. 12, the pre-generated music is displayed in the second interface, and when the pre-generated music is played to time t_1 (playback timestamp), the user clicks an editing component in the second interface to jump to the third interface, and a soundtrack element in a time period starting from time t_1 and ending at time t_1+det is displayed in the third interface, where det is a value greater than or equal to the minimum adopted interval, representing an editing interval of the soundtrack element. The soundtrack element is realized by a sound channel, such as shown in the figure, the soundtrack element include a drum sound effect (the corresponding element identification is Rhy_1), an ambient sound effect (the corresponding element identification is Amb_1), a bass sound effect (the corresponding element identification is Bas_1), a harmony sound effect (the corresponding element identification is Harm_1), a main melody sound effect (the corresponding element identification is Lea_1). Each soundtrack element corresponds to one sound channel, and the sound channel carries specific sound data of the specific soundtrack element, that is, the implementation manner.

Further, when the user applies a third setting operation to the soundtrack element (corresponding component) in the third interface, the terminal device will correspondingly change the specific implementation of the soundtrack element according to a setting instruction corresponding to the third setting operation, thereby generating a new arrangement, that is, a second arrangement.

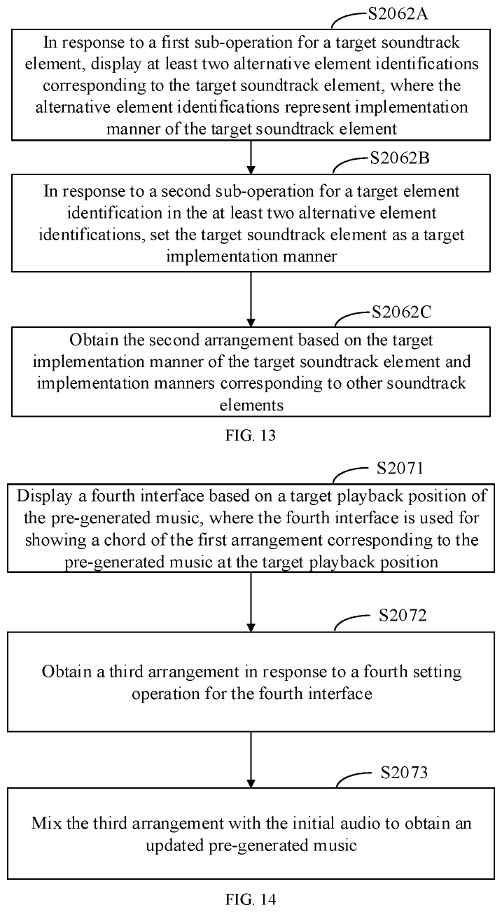

Exemplarily, the third setting operation at least includes a first sub-operation and a second sub-operation performed sequentially. As shown in FIG. 13, the specific implementation manner of step S2062 includes:
step S2062A: in response to a first sub-operation for a target soundtrack element, display at least two alternative element identifications corresponding to the target soundtrack element, where the alternative element identifications represent implementation manner of the target soundtrack element;
step S2062B: in response to a second sub-operation for a target element identification in the at least two alternative element identifications, set the target soundtrack element as a target implementation manner;
step S2062C: obtain the second arrangement based on the target implementation manner of the target soundtrack element and implementation manners corresponding to other soundtrack elements.

Exemplarily, in conjunction with the third interface shown in FIG. 12, when the bass sound effect is the selected target soundtrack element, in response to a first sub-operation of an element identification corresponding to the bass sound effect, multiple alternative element identifications are displayed in the form of a drop-down menu, and then one of the alternative element identifications is selected as the target element identification (shown as Bas_1 in the figure) based on a second sub-operation and is displayed. At the same time, the second arrangement is obtained based on the target implementation manner corresponding to the target element identification of the bass sound effect and current implementation manners of the drum sound effect, the harmony sound effect, the ambient sound effect, the main melody sound effect.

Step S2063: determine the second arrangement as the updated first arrangement.

Exemplarily, the second arrangement is determined as the updated first arrangement, and the step S204 may be returned to realize the update of the pre-generated music. In the present embodiment, the second arrangement is obtained by modifying the soundtrack element in response to the third setting operation on the third interface, so as to realize the update of the pre-generated music, further improve the flexibility of arrangement and meet the personalized needs of the user.

Step S207: update a chord of the pre-generated music to generate an updated first arrangement.

Exemplarily, as shown in FIG. 14, the specific implementation manners of step S207 includes:
step S2071: display a fourth interface based on a target playback position of the pre-generated music, where the fourth interface is used for showing a chord of the first arrangement corresponding to the pre-generated music at the target playback position;
step S2072: obtain a third arrangement in response to a fourth setting operation for the fourth interface;
step S2073: mix the third arrangement and the initial audio to obtain an updated pre-generated music.

Exemplarily, similar to the manner of setting the soundtrack element, in the process of displaying and playing the pre-generated music in the second interface, when the pre-generated music is played at the target playback position, or jumps (seek) to the target playback position based on the user's operation, the terminal device displays the fourth interface after receiving a trigger operation for the fourth interface input by the user, where the fourth interface is used for showing a chord of the first arrangement corresponding to the pre-generated music at the target playback position, and then the user may implement the fourth setting operation on the basis of the fourth interface, so as to realize the setting of the chord. Specifically, the chord refers to a group of sounds having a certain musical interval relationship, that is, three or more notes are combined longitudinally in a three-degree or non-three-degree overlapping relationship, which is called chord. The chord typically includes triad (three-tone chord), seventh chord (four-tone chord), ninth chord (five-tone chord) and the like. Based on the different implementation forms of the chord, the corresponding number of syllable components may be displayed in the fourth interface, and syllable content corresponding to the syllable components is changed based on the fourth setting operation to realize different syllable combinations, thus realizing different chords. The specific display manner and specific setting manner of the fourth interface may be set as required, which are not specifically limited here.

The second arrangement is determined as the updated first arrangement, and the step S204 may be returned to realize the update of the pre-generated music. In the present embodiment, the third arrangement is obtained by modifying the chord in response to the fourth setting operation on the fourth interface, so as to realize the update of the pre-generated music, further improve the flexibility of arrangement and meet the personalized needs of the user.

Step S208: export the pre-generated music in response to a second trigger operation to generate the target music.

Exemplarily, after the above at least one step of generating the pre-generated music, data export is performed on the personalized pre-generated music that meets the needs of the user, for example, through an export component in the second interface shown in FIG. 12, the pre-generated music is generated into target music that can be directly played, such as music files in mp3 and wav formats, so as to realize the production process of musical creations. In an implementation, at the same time, a music cover that matches the target music may be further generated, for example, a picture and a video matching the soundtrack of the target music is used as a music cover, and the target music and the music cover are published, and the specific implementation process will not be repeated here.

In the present embodiment, on the basis of automatically generating the first arrangement template, the automatically selected arrangement template may be further modified based on the user's setting operation, and the soundtrack elements, chords and mixing coefficients are adjusted to realize more detailed soundtrack setting, thereby generating musical creations that meet the personalized needs of the user.

In the present embodiment, the implementation manners of steps S201-S202 are the same as those of steps S101-S102 in the embodiment shown in FIG. 2 of the present disclosure, and will not repeated here.

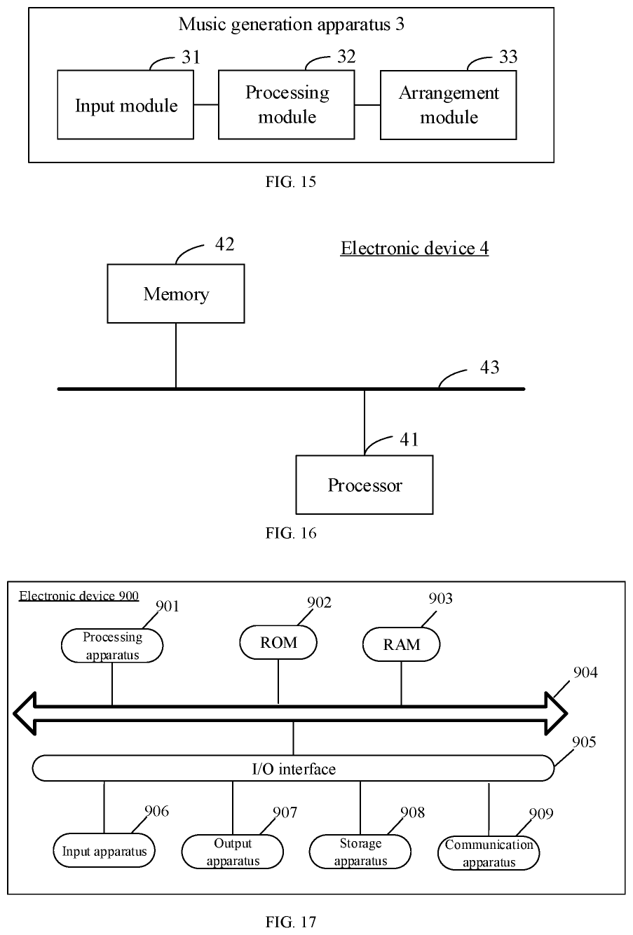

Corresponding to the music generation method of the above embodiments, FIG. 15 is a structural block diagram of a music generation apparatus provided by an embodiment of the present disclosure. For ease of illustration, only portions related to embodiments of the present disclosure are shown. With reference to FIG. 15, the music generation apparatus 3 includes:
an input module 31, configured to acquire initial audio;
a processing module 32, configured to acquire a first arrangement template corresponding to the initial audio, where the first arrangement template is used for adding a soundtrack with a target music style to the initial audio;
an arrangement module 33, configured to process the initial audio based on the first arrangement template to generate target music.

In an embodiment of the present disclosure, the input module 31 is specifically configured to: collect real-time voice data in response to a first trigger operation in a first interface: after reaching a preset condition, generate the initial audio based on real-time voice data collected at different times; the input module 31 is further configured to: display waveform corresponding to the real-time voice data in the first interface in real time.

In an embodiment of the present disclosure, before acquiring the initial audio, the input module 31 is further configured to: receive a first setting operation for a first setting component in the first interface, where the first setting operation is used for setting a target type of a vocal effect: the input module 31 is specifically configured to: perform sound collection in response to the first trigger operation to obtain an original voice: process the original voice to obtain the initial audio with the target type of the vocal effect.

In an embodiment of the present disclosure, the arrangement module 33 is specifically configured to: obtain a first arrangement with the target music style according to the first arrangement template: mix the first arrangement with the initial audio to generate pre-generated music: export the pre-generated music in response to a second trigger operation to generate the target music.

In an embodiment of the present disclosure, after mixing the first arrangement with the initial audio to generate the pre-generated music, the arrangement module 33 is further configured for at least one of the following: displaying a first template identification corresponding to the first arrangement template and a second template identification corresponding to at least one alternative arrangement template in a second interface, where the first template identification and at least one second template identification are arranged based on a target arrangement order, and the target arrangement order is determined at least based on a first arrangement information of the initial audio, and the first arrangement information represents a melody characteristic of the soundtrack adapted to the initial audio; generating an updated first arrangement in response to a selection operation for the alternative arrangement template.

In an embodiment of the present disclosure, after mixing the first arrangement with the initial audio to generate the pre-generated music, the arrangement module 33 is further configured to: display a third interface based on a target playback position of the pre-generated music, where the third interface is used for showing a soundtrack element of the first arrangement corresponding to the pre-generated music at the target playback position: obtain a second arrangement in response to a third setting operation for the third interface; mix the second arrangement with the initial audio to obtain the updated pre-generated music.

In an embodiment of the present disclosure, the third setting operation at least includes a first sub-operation and a second sub-operation performed sequentially, when obtaining the second arrangement in response to the third setting operation for the third interface, the arrangement module 33 is specifically configured to: in response to a first sub-operation for a target soundtrack element, display at least two alternative element identifications corresponding to the target soundtrack element, where the alternative element identifications represent implementation manner of the target soundtrack element: in response to a second sub-operation for a target element identification in the at least two alternative element identifications, set the target soundtrack element as a target implementation manner: obtain the second arrangement based on the target implementation manner of the target soundtrack element and implementation manners corresponding to other soundtrack elements.

In an embodiment of the present disclosure, the soundtrack element includes at least one of the following: a musical instrument sound effect, a harmonic sound effect, and a main melody sound effect.

In an embodiment of the present disclosure, after mixing the first arrangement with the initial audio to generate the pre-generated music, the arrangement module 33 is further configured to: display a fourth interface based on a target playback position of the pre-generated music, where the fourth interface is used for showing a chord of the first arrangement corresponding to the pre-generated music at the target playback position: obtain a third arrangement in response to a fourth setting operation for the fourth interface: mix the third arrangement with the initial audio to obtain the updated pre-generated music.

In an embodiment of the present disclosure, before mixing the first arrangement with the initial audio to generate the pre-generated music, the arrangement module 33 is further configured to: display a fifth interface, where the fifth interface is used for setting a mixing coefficient of the first arrangement and the initial audio, and the mixing coefficient represents respective volume values of the first arrangement and the initial audio when mixed: in response to a fifth setting operation for the fifth interface, obtain a target mixing coefficient: when mixing the first arrangement with the initial audio to generate the pre-generated music, the arrangement module 33 is specifically configured to: mix the first arrangement with the initial audio based on the target mixing coefficient to generate pre-generated music.

In an embodiment of the present disclosure, the processing module 32 is specifically configured to: acquire first arrangement information of the initial audio, where the first arrangement information represents a melody characteristic of a soundtrack adapted to the initial audio: obtain the first arrangement template according to the first arrangement information.

In an embodiment of the present disclosure, when acquiring the first arrangement information of the initial audio, the processing module 32 is specifically configured to: obtain voice beat of the initial audio according to pitch change of the initial audio: obtain a corresponding soundtrack beat according to the voice beat of the initial audio: obtain the first arrangement information according to the soundtrack beat.

In an embodiment of the present disclosure, when acquiring the first arrangement information of the initial audio, the processing module 32 is specifically configured to: in response to a second setting operation for a second setting component in a first interface, obtain second recording information, where the second recording information represents a soundtrack beat and/or a playback speed of the initial audio; obtain the first arrangement information according to the second recording information.

The input module 31, the processing module 32 and the arrangement module 33 are connected in sequence. The music generation apparatus 3 provided in the present embodiment may execute the technical solution of the above-mentioned method embodiments, and the implementation principles and technical effects are similar, which will not be described in detail in the present embodiment.

FIG. 16 is a schematic structural diagram of an electronic device provided by an embodiment of the present disclosure, as shown in FIG. 16, the electronic device 4 includes:
a processor 41 and a memory 42 connected to the processor 41 in a communication way;
where the memory 42 stores computer executable instructions;
the processor 41 executes the computer executable instructions stored in the memory 42 to implement the music generation methods in embodiments shown in FIGS. 2-14.

In an implementation, the processor 41 and the memory 42 are connected via a bus 43.

The relevant description may be understood with reference to the relevant description and effects corresponding to the steps in the embodiments corresponding to FIGS. 2-14, which will not be repeated herein.

An embodiment of the present disclosure provides a computer-readable storage medium storing computer executable instructions, when the computer executable instructions are executed by a processor, the music generation method provided by any one of the embodiments corresponding to FIGS. 2-14 of the present disclosure is implemented.

An embodiment of the present disclosure provides a computer program product including a computer program, when the computer program is executed by a processor, the music generation methods in the embodiments shown in FIGS. 2-14 are implemented.

Referring to FIG. 17, a schematic structural diagram of an electronic device 900 suitable for implementing an embodiment of the present disclosure is shown. The electronic device 900 may be a terminal device or a server. The terminal device may include, but is not limited to, a mobile terminal such as a mobile phone, a notebook computer, a digital broadcast receiver, a personal digital assistant (PDA), a portable android device (PAD), a portable media player (PMP), a vehicle terminal (e.g. a vehicle navigation terminal), etc., and a fixed terminal such as a digital TV, a desktop computer, and the like. The electronic device 900 shown in FIG. 17 is only one example, and should not bring about any limitation to functions and usage scopes of the embodiments of the present disclosure.

As shown in FIG. 17, the electronic device 900 may include a processing apparatus (for example, a central processing unit, a graphic processor, etc.) 901, which may perform various appropriate actions and processing according to a program stored in a read only memory (ROM) 902 or a program loaded from a storage apparatus 908 to a random access memory (RAM) 903. In the RAM 903, various programs and data required for operations of the electronic device 900 may also be stored. The processing apparatus 901, the ROM 902, and the RAM 903 are connected to each other by a bus 904. An input/output (I/O) interface 905 is also connected to the bus 904.

Generally, the following apparatuses may be connected to the I/O interface 905: an input apparatus 906, which includes, for example, a touch screen, a touch pad, a keyboard, a mouse, a camera, a microphone, an accelerometer, a gyroscope, etc.: an output apparatus 907, which includes, for example, a liquid crystal display (LCD), a speaker, a vibrator, etc.; a storage apparatus 908, which includes, for example, a magnetic tape, a hard disk, etc.; and a communication apparatus 909. The communication apparatus 909 may allow the electronic device 900 to communicate with other devices in a wireless or wired way, to exchange data. Although FIG. 17 shows the electronic device 900 having various apparatuses, it should be understood that it is not required to implement or have all of the shown apparatuses. It is alternatively possible to implement or have more or fewer apparatuses.

In particular, according to an embodiment of the present disclosure, processes described above with reference to the flowcharts may be implemented as a computer software program. For example, an embodiment of the present disclosure includes a computer program product which includes a computer program carried on a computer readable medium, and the computer program contains program codes used for executing the method shown in the flowcharts. In such embodiment, the computer program may be downloaded and installed from a network via the communication apparatus 909, or installed from the storage apparatus 908, or installed from the ROM 902. When the computer program is executed by the processing apparatus 901, the above functions defined in the method of the embodiments of the present disclosure are performed.

It should be noted that the above computer readable medium in the present disclosure may be a computer readable signal medium, or a computer readable storage medium, or a combination of both. The computer readable storage medium may be, for example, but not limited to, an electrical, a magnetic, an optical, an electromagnetic, an infrared, or a semiconductor system, apparatus or device, or any combination of the above. More specific examples of the computer readable storage medium may include, but are not limited to: an electrical connection with one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the above. In the present disclosure, a computer readable storage medium may be any tangible medium that contains or stores a program, and the program may be used by or in combination with an instruction executive system, apparatus, or device. In the present disclosure, a computer readable signal medium may include a data signal propagated in a baseband or as a part of a carrier wave, and a computer readable program code is carried therein. This propagated data signal may adopt many forms, including but not limited to, an electromagnetic signal, an optical signal, or any suitable combination of the above. The computer readable signal medium may also be any computer readable media other than the computer readable storage medium, and the computer readable signal medium may send, propagate, or transmit the program used by or in combination with the instruction executive system, apparatus, or device. The program code contained on the computer readable medium may be transmitted by any suitable medium, including but not limited to: a wire, an optical cable, a RF (radio frequency), etc., or any suitable combination of the above.

The above-mentioned computer readable medium may be included in the above-mentioned electronic device: or it may exist alone without being assembled into the electronic device.

The above-mentioned computer readable medium carries one or more programs, and when the above-mentioned one or more programs are executed by the electronic device, the electronic device is caused to execute the method shown in above embodiments.

The computer program code used to perform operations of the present disclosure may be written in one or more programming languages or a combination thereof. The above-mentioned programming languages include object-oriented programming languages—such as Java, Smalltalk, C++, and also include conventional procedural programming languages—such as “C” language or similar programming languages. The program code may be executed entirely on a computer of a user, partly on a computer of a user, executed as an independent software package, partly executed on a computer of a user and partly executed on a remote computer, or entirely executed on a remote computer or a server. In a case where a remote computer is involved, the remote computer may be connected to the computer of the user through any kind of network—including a local area network (LAN) or a wide area network (WAN), or, it may be connected to an external computer (for example, use an Internet service provider to connect via the Internet).

The flowcharts and block diagrams in the drawings illustrate possible implementation architecture, functions, and operations of the system, method, and computer program product in accordance with the embodiments of the present disclosure. At this point, each block in the flowchart or the block diagram may represent a module, a program segment, or a part of code, and the module, the program segment, or the part of code contains one or more executable instructions for implementing a specified logical function. It should also be noted that, in some alternative implementations, the functions marked in the blocks may also occur in a different order from the order marked in the drawings. For example, two blocks shown one after another may actually be executed substantially in parallel, or sometimes may be executed in a reverse order, which depends on the functions involved. It should also be noted that, each block in the block diagram and/or flowchart, and a combination of the blocks in the block diagram and/or flowchart, may be implemented by a dedicated hardware-based system that performs the specified functions or operations, or may be implemented by a combination of dedicated hardware and computer instructions.

The units involved in the embodiments described in the present disclosure may be implemented in software or hardware. Where a name of the unit does not constitute a limitation on the unit itself in some cases. For example, the first obtaining unit may also be described as “a unit that acquires at least two Internet Protocol addresses”.

The functions herein described above may be performed at least in part by one or more hardware logic assemblies. For example, without limitation, exemplary types of hardware logic assemblies that may be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine readable medium may be a tangible medium that may contain or store programs for use by or in combination with an instruction executive system, apparatus or device. The machine readable medium may be a machine readable signal medium or a machine readable storage medium. The machine readable medium may include, but is not limited to, an electronic, a magnetic, an optical, an electromagnetic, an infrared, or a semiconductor system, apparatus or device, or any suitable combination of the above. More specific examples of the machine readable storage medium will include an electrical connection based on one or more lines, a portable computer disk, a hard disk, a random access memory (RAM), a read only memory (ROM), an erasable programmable read only memory (EPROM or a flash memory), an optical fiber, a portable compact disc read only memory (CD-ROM), an optical storage device, a magnetic storage device, or any suitable combination thereof.

In a first aspect, according to one or more embodiments of the present disclosure, there is provided a music generation method, including:
acquiring initial audio: acquiring a first arrangement template corresponding to the initial audio, where the first arrangement template is used for adding a soundtrack with a target music style to the initial audio: processing the initial audio based on the first arrangement template to generate target music.

According to one or more embodiments of the present disclosure, the acquiring the initial audio includes: collecting real-time voice data in response to a first trigger operation in a first interface: after reaching a preset condition, generating the initial audio based on real-time voice data collected at different times: the method further includes: displaying waveform corresponding to the real-time voice data in the first interface in real time.

According to one or more embodiments of the present disclosure, before acquiring the initial audio, the method further includes: receiving a first setting operation for a first setting component in the first interface, where the first setting operation is used for setting a target type of a vocal effect: the acquiring the initial audio includes: performing sound collection in response to the first trigger operation to obtain an original voice: processing the original voice to obtain the initial audio with the target type of the vocal effect.

According to one or more embodiments of the present disclosure, the processing the initial audio based on the first arrangement template to generate the target music includes: obtaining a first arrangement with the target music style according to the first arrangement template; mixing the first arrangement with the initial audio to generate pre-generated music; and exporting the pre-generated music in response to a second trigger operation to generate the target music.

According to one or more embodiments of the present disclosure, after mixing the first arrangement with the initial audio to generate the pre-generated music, the method further includes at least one of the following: displaying a first template identification corresponding to the first arrangement template and a second template identification corresponding to at least one alternative arrangement template in a second interface, where the first template identification and at least one second template identification are arranged based on a target arrangement order, and the target arrangement order is determined at least based on a first arrangement information of the initial audio, and the first arrangement information represents a melody characteristic of the soundtrack adapted to the initial audio: generating an updated first arrangement in response to a selection operation for the alternative arrangement template.

According to one or more embodiments of the present disclosure, after mixing the first arrangement with the initial audio to generate the pre-generated music, the method further includes: displaying a third interface based on a target playback position of the pre-generated music, where the third interface is used for showing a soundtrack element of the first arrangement corresponding to the pre-generated music at the target playback position: obtaining a second arrangement in response to a third setting operation for the third interface: mixing the second arrangement with the initial audio to obtain the updated pre-generated music.

According to one or more embodiments of the present disclosure, the third setting operation at least includes a first sub-operation and a second sub-operation performed sequentially, the obtaining the second arrangement in response to the third setting operation for the third interface includes: in response to a first sub-operation for a target soundtrack element, displaying at least two alternative element identifications corresponding to the target soundtrack element, where the alternative element identifications represent implementation manner of the target soundtrack element: in response to a second sub-operation for a target element identification in the at least two alternative element identifications, setting the target soundtrack element as a target implementation manner: obtaining the second arrangement based on the target implementation manner of the target soundtrack element and implementation manners corresponding to other soundtrack elements.

According to one or more embodiments of the present disclosure, the soundtrack element includes at least one of the following: a musical instrument sound effect, a harmonic sound effect, a main melody sound effect.

According to one or more embodiments of the present disclosure, after mixing the first arrangement with the initial audio to generate the pre-generated music, the method further includes: displaying a fourth interface based on a target playback position of the pre-generated music, where the fourth interface is used for showing a chord of the first arrangement corresponding to the pre-generated music at the target playback position: obtaining a third arrangement in response to a fourth setting operation for the fourth interface: mixing the third arrangement with the initial audio to obtain the updated pre-generated music.

According to one or more embodiments of the present disclosure, before mixing the first arrangement with the initial audio to generate the pre-generated music, the method further includes: displaying a fifth interface, where the fifth interface is used for setting a mixing coefficient of the first arrangement and the initial audio, and the mixing coefficient represents respective volume values of the first arrangement and the initial audio when mixed: in response to a fifth setting operation for the fifth interface, obtaining a target mixing coefficient: the mixing the first arrangement with the initial audio to generate the pre-generated music includes: mixing the first arrangement with the initial audio based on the target mixing coefficient to generate pre-generated music.

According to one or more embodiments of the present disclosure, the acquiring the first arrangement template corresponding to the initial audio includes: acquiring first arrangement information of the initial audio, where the first arrangement information represents a melody characteristic of a soundtrack adapted to the initial audio: obtaining the first arrangement template according to the first arrangement information.

According to one or more embodiments of the present disclosure, the acquiring the first arrangement information of the initial audio includes: obtaining voice beat of the initial audio according to pitch change of the initial audio: obtaining a corresponding soundtrack beat according to the voice beat of the initial audio; obtaining the first arrangement information according to the soundtrack beat.

According to one or more embodiments of the present disclosure, the acquiring the first arrangement information of the initial audio includes: in response to a second setting operation for a second setting component in a first interface, obtaining second recording information, where the second recording information represents a soundtrack beat and/or a playback speed of the initial audio: obtaining the first arrangement information according to the second recording information.

In a second aspect, according to one or more embodiments of the present disclosure, there is provided a music generation apparatus, including:
an input module, configured to acquire initial audio;
a processing module, configured to acquire a first arrangement template corresponding to the initial audio, where the first arrangement template is used for adding a soundtrack with a target music style to the initial audio;
an arrangement module, configured to process the initial audio based on the first arrangement template to generate target music.

According to one or more embodiments of the present disclosure, the input module is specifically configured to: collect real-time voice data in response to a first trigger operation in a first interface: after reaching a preset condition, generate the initial audio based on real-time voice data collected at different times: the input module is further configured to: display waveform corresponding to the real-time voice data in the first interface in real time.

According to one or more embodiments of the present disclosure, before acquiring the initial audio, the input module is further configured to: receive a first setting operation for a first setting component in the first interface, where the first setting operation is used for setting a target type of a vocal effect: the input module is specifically configured to: perform sound collection in response to the first trigger operation to obtain an original voice: process the original voice to obtain the initial audio with the target type of the vocal effect.

According to one or more embodiments of the present disclosure, the arrangement module is specifically configured to: obtain a first arrangement with the target music style according to the first arrangement template: mix the first arrangement with the initial audio to generate pre-generated music: export the pre-generated music in response to a second trigger operation to generate the target music.

According to one or more embodiments of the present disclosure, after mixing the first arrangement with the initial audio to generate the pre-generated music, the arrangement module is further configured for at least one of the following: displaying a first template identification corresponding to the first arrangement template and a second template identification corresponding to at least one alternative arrangement template in a second interface, where the first template identification and at least one second template identification are arranged based on a target arrangement order, and the target arrangement order is determined at least based on a first arrangement information of the initial audio, and the first arrangement information represents a melody characteristic of the soundtrack adapted to the initial audio; generating an updated first arrangement in response to a selection operation for the alternative arrangement template.

According to one or more embodiments of the present disclosure, after mixing the first arrangement with the initial audio to generate the pre-generated music, the arrangement module is further configured to: display a third interface based on a target playback position of the pre-generated music, where the third interface is used for showing a soundtrack element of the first arrangement corresponding to the pre-generated music at the target playback position: obtain a second arrangement in response to a third setting operation for the third interface; mix the second arrangement with the initial audio to obtain the updated pre-generated music.

According to one or more embodiments of the present disclosure, the third setting operation at least includes a first sub-operation and a second sub-operation performed sequentially, when obtaining the second arrangement in response to the third setting operation for the third interface, the arrangement module is specifically configured to: in response to a first sub-operation for a target soundtrack element, display at least two alternative element identifications corresponding to the target soundtrack element, where the alternative element identifications represent implementation manner of the target soundtrack element: in response to a second sub-operation for a target element identification in the at least two alternative element identifications, set the target soundtrack element as a target implementation manner; obtain the second arrangement based on the target implementation manner of the target soundtrack element and implementation manners corresponding to other soundtrack elements.

According to one or more embodiments of the present disclosure, the soundtrack element includes at least one of the following: a musical instrument sound effect, a harmonic sound effect, and a main melody sound effect.

According to one or more embodiments of the present disclosure, after mixing the first arrangement with the initial audio to generate the pre-generated music, the arrangement module is further configured to: display a fourth interface based on a target playback position of the pre-generated music, where the fourth interface is used for showing a chord of the first arrangement corresponding to the pre-generated music at the target playback position: obtain a third arrangement in response to a fourth setting operation for the fourth interface: mix the third arrangement with the initial audio to obtain the updated pre-generated music.

According to one or more embodiments of the present disclosure, before mixing the first arrangement with the initial audio to generate the pre-generated music, the arrangement module is further configured to: display a fifth interface, where the fifth interface is used for setting a mixing coefficient of the first arrangement and the initial audio, and the mixing coefficient represents respective volume values of the first arrangement and the initial audio when mixed: in response to a fifth setting operation for the fifth interface, obtain a target mixing coefficient: when mixing the first arrangement with the initial audio to generate the pre-generated music, the arrangement module is specifically configured to: mix the first arrangement with the initial audio based on the target mixing coefficient to generate pre-generated music.

According to one or more embodiments of the present disclosure, the processing module is specifically configured to: acquire first arrangement information of the initial audio, where the first arrangement information represents a melody characteristic of a soundtrack adapted to the initial audio: obtain the first arrangement template according to the first arrangement information.

According to one or more embodiments of the present disclosure, when acquiring the first arrangement information of the initial audio, the processing module is specifically configured to: obtain voice beat of the initial audio according to pitch change of the initial audio: obtain a corresponding soundtrack beat according to the voice beat of the initial audio: obtain the first arrangement information according to the soundtrack beat.

According to one or more embodiments of the present disclosure, when acquiring the first arrangement information of the initial audio, the processing module is specifically configured to: in response to a second setting operation for a second setting component in a first interface, obtain second recording information, where the second recording information represents a soundtrack beat and/or a play back speed of the initial audio: obtain the first arrangement information according to the second recording information.

In a third aspect, according to one or more embodiments of the present disclosure, there is provided an electronic device including: a processor and a memory connected to the processor in a communication way:
where the memory stores computer executable instructions;
the processor executes the computer executable instructions stored in the memory to implement the music generation methods as described above in the first aspect and the various possible designs of the first aspect.

In a fourth aspect, according to one or more embodiments of the present disclosure, there is provided a computer-readable storage medium storing a computer executable instruction, when the computer executable instruction is executed by a processor, the music generation methods as described above in the first aspect and the various possible designs of the first aspect are implemented.

In a fifth aspect, an embodiment of the present disclosure provides a computer program product including a computer program, when the computer program is executed by a processor, the music generation methods as described above in the first aspect and the various possible designs of the first aspect are implemented.

The above description is only preferred embodiments of the present disclosure and an illustration of the applied technical principles. Those skilled in the art should understand that, the disclosure scope involved in the present disclosure is not limited to the technical solutions formed by the specific combination of the above technical features, but also covers other technical solutions formed by the arbitrary combination of the above technical features or their equivalent features without departing from the above disclosure concept, for example, a technical solution formed by replacing the above features with technical features with similar functions disclosed (but not limited to) in the present disclosure.

In addition, although each operation is described in a specific order, this should not be understood as requiring these operations to be performed in the specific order or in a sequential order shown. Under certain circumstances, multitasking and parallel processing may be advantageous. Similarly, although several specific implementation details are included in the above discussion, these should not be interpreted as limiting the scope of the present disclosure. Certain features described in the context of a single embodiment may also be implemented in combination in the single embodiment. Conversely, various features described in the context of a single embodiment may also be implemented in multiple embodiments individually or in any suitable sub combination.

Although the subject matter has been described in a language specific to structural features and/or method logical actions, it should be understood that the subject matter defined in the appended claims is not limited to the specific features or actions described above. On the contrary, the specific features and actions described above are only exemplary forms for implementing the claims.

What is claimed is:

1. A music generation method, comprising:
acquiring initial audio;
acquiring a first arrangement template corresponding to the initial audio, wherein the first arrangement template is used for adding a soundtrack with a target music style to the initial audio;
processing the initial audio based on the first arrangement template to generate target music.

2. The method according to claim 1, wherein the acquiring the initial audio comprises:
collecting real-time voice data in response to a first trigger operation in a first interface;
after reaching a preset condition, generating the initial audio based on real-time voice data collected at different times;
the method further comprises;
displaying waveform corresponding to the real-time voice data in the first interface in real time.

3. The method according to claim 2, before collecting the real-time voice data in response to the first trigger operation in the first interface, further comprising:
receiving a first setting operation for a first setting component in the first interface, wherein the first setting operation is used for setting a target type of vocal effect;
the collecting the real-time voice data in response to the first trigger operation in the first interface comprises:
performing sound collection in response to the first trigger operation to obtain an original voice;
processing the original voice to obtain the initial audio with the target type of the vocal effect.

4. The method according to claim 1, wherein the acquiring the initial audio comprises:
selecting a voice file in response to a first loading operation in a first interface;
loading the voice file to obtain the initial audio.

5. The method according to claim 1, wherein the processing the initial audio based on the first arrangement template to generate the target music comprises:
obtaining a first arrangement with the target music style according to the first arrangement template;
mixing the first arrangement with the initial audio to generate pre-generated music;
exporting the pre-generated music in response to a second trigger operation to generate the target music;
before generating the target music, the method further comprises:
editing the pre-generated music to obtain an updated pre-generated music.

6. The method according to claim 5, after mixing the first arrangement with the initial audio to generate the pre-generated music, further comprising at least one of the following:
displaying a first template identification corresponding to the first arrangement template and a second template identification corresponding to at least one alternative arrangement template in a second interface, wherein the first template identification and at least one second template identification are arranged based on a target arrangement order, and the target arrangement order is determined at least based on first arrangement information of the initial audio, and the first arrangement information represents a melody characteristic of the soundtrack adapted to the initial audio;
generating an updated first arrangement in response to a selection operation for the alternative arrangement template.

7. The method according to claim 5, after mixing the first arrangement with the initial audio to generate the pre-generated music, further comprising:
displaying a third interface based on a target playback position of the pre-generated music, wherein the third interface is used for showing a soundtrack element of the first arrangement corresponding to the pre-generated music at the target playback position;
obtaining a second arrangement in response to a third setting operation for the third interface;
mixing the second arrangement with the initial audio to obtain the updated pre-generated music.

8. The method according to claim 7, wherein the third setting operation at least comprises a first sub-operation and a second sub-operation performed sequentially, the obtaining the second arrangement in response to the third setting operation for the third interface comprises:
in response to a first sub-operation for a target soundtrack element, displaying at least two alternative element identifications corresponding to the target soundtrack element, wherein the alternative element identifications represent implementation manner of the target soundtrack element;
in response to a second sub-operation for a target element identification in the at least two alternative element identifications, setting the target soundtrack element as a target implementation manner;
obtaining the second arrangement based on the target implementation manner of the target soundtrack element and implementation manners corresponding to other soundtrack elements.

9. The method according to claim 7, wherein the soundtrack element comprises at least one of the following:
a musical instrument sound effect, a harmonic sound effect, and a main melody sound effect.

10. The method according to claim 5, after mixing the first arrangement with the initial audio to generate the pre-generated music, further comprising:
displaying a fourth interface based on a target playback position of the pre-generated music, wherein the fourth interface is used for showing a chord of the first arrangement corresponding to the pre-generated music at the target playback position;
obtaining a third arrangement in response to a fourth setting operation for the fourth interface;
mixing the third arrangement with the initial audio to obtain the updated pre-generated music.

11. The method according to claim 5, before mixing the first arrangement with the initial audio to generate the pre-generated music, further comprising:
displaying a fifth interface, wherein the fifth interface is used for setting a mixing coefficient of the first arrangement and the initial audio, and the mixing coefficient represents respective volume values of the first arrangement and the initial audio when mixed;
in response to a fifth setting operation for the fifth interface, obtaining a target mixing coefficient;
the mixing the first arrangement with the initial audio to generate the pre-generated music comprises:
mixing the first arrangement with the initial audio based on the target mixing coefficient to generate pre-generated music.

12. The method according to claim 1, wherein the acquiring the first arrangement template corresponding to the initial audio comprises:
acquiring first arrangement information of the initial audio, wherein the first arrangement information represents a melody characteristic of a soundtrack adapted to the initial audio;
obtaining the first arrangement template according to the first arrangement information.

13. The method according to claim 11, wherein the acquiring the first arrangement information of the initial audio comprises:
obtaining voice beat of the initial audio according to pitch change of the initial audio;
obtaining a corresponding soundtrack beat according to the voice beat of the initial audio;
obtaining the first arrangement information according to the soundtrack beat.

14. The method according to claim 11, wherein the acquiring the first arrangement information of the initial audio comprises:
in response to a second setting operation for a second setting component in a first interface, obtaining second recording information, wherein the second recording information represents a soundtrack beat and/or a playback speed of the initial audio;
obtaining the first arrangement information according to the second recording information.

15. An electronic device, comprising: a processor and a memory connected to the processor in a communication way:
wherein the memory stores computer executable instructions;
the computer executable instructions stored in the memory are executed by the processor, the processor is caused to:
acquire initial audio;
acquire a first arrangement template corresponding to the initial audio, wherein the first arrangement template is used for adding a soundtrack with a target music style to the initial audio;
process the initial audio based on the first arrangement template to generate target music.

16. The electronic device according to claim 15, wherein the processor is caused to:
collect real-time voice data in response to a first trigger operation in a first interface;
after reaching a preset condition, generate the initial audio based on real-time voice data collected at different times;
the processor is further caused to:
display waveform corresponding to the real-time voice data in the first interface in real time.

17. The electronic device according to claim 16, before collecting the real-time voice data in response to the first trigger operation in the first interface, the processor is further caused to:
receive a first setting operation for a first setting component in the first interface, wherein the first setting operation is used for setting a target type of vocal effect;
perform sound collection in response to the first trigger operation to obtain an original voice;
process the original voice to obtain the initial audio with the target type of the vocal effect.

18. The electronic device according to claim 15, wherein the processor is caused to:
select a voice file in response to a first loading operation in a first interface;
load the voice file to obtain the initial audio.

19. The electronic device according to claim 15, wherein the processor is caused to:
obtain a first arrangement with the target music style according to the first arrangement template;
mix the first arrangement with the initial audio to generate pre-generated music;
export the pre-generated music in response to a second trigger operation to generate the target music;
before generating the target music, the processor is further caused to:
edit the pre-generated music to obtain an updated pre-generated music.

20. A non-transitory computer-readable storage medium, wherein the computer readable storage medium stores computer executable instructions, and when a processor executes the computer executable instructions, the processor is caused to:
acquire initial audio;
acquire a first arrangement template corresponding to the initial audio, wherein the first arrangement template is used for adding a soundtrack with a target music style to the initial audio;
process the initial audio based on the first arrangement template to generate target music.
